(19) United States
(12) Patent Application Publication
(10) Pub. No.: US 2007/0051494 A1
(43) Pub. Date: Mar. 8, 2007

(54) Cooling module and elastic bearing therefor

(76) Inventors: Jochen Orso, Reutlingen (DE); Werner Nitsche, Kirchheim/Teck (DE); Fidel Hassler, Abtsgmund (DE); Sumanoharan Narayanan, Neu-Ulm (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/510,205

(22) Filed: Aug. 25, 2006

(30) Foreign Application Priority Data
Aug. 27, 2005 (DE) DE102005040721.8

(51) Int. Cl. B60H 1/00; F28F 9/00

(52) U.S. Cl. 165/67; 165/41

(57) ABSTRACT

A cooling module for a vehicle, including at least two heat exchangers with holding brackets secured to the sides, and a support having two elastic bearings adapted to rest on carriers of the vehicle and secured to the holding brackets. The elastic bearings include an elastic element between at least first and second members whereby the heat exchangers are supported individually elastically.

### CROSS REFERENCE TO RELATED APPLICATION(S)

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The invention relates to a cooling module with at least two heat exchangers, and more particularly to a vibration-damping support for the heat exchangers.

### BACKGROUND OF THE INVENTION AND TECHNICAL PROBLEMS POSED BY THE PRIOR ART

Cooling modules with multiple heat exchangers, for example a radiator and a charge air cooler, for a motor vehicle, are known. For example, in DE 100 18 000 B4 and DE 44 11 456 B4, holding brackets support the entire cooling module, with the brackets fastened at the inlet and outlet connections of the charge air cooler and the water cooler or the radiator fastened on the charge air cooler. The bracket supports include vibration-damping for the supported module. However, vibrations which are not compensated by the vibration-damping support are transferred directly from the charge air cooler to the radiator (or water cooler). Furthermore, the joint between the coolers can have an adverse effect on the expansion and contraction process of the cooler, which occurs as a result of the temperature change load.

The present invention is directed toward overcoming one or more of the problems set forth above.

### SUMMARY OF THE INVENTION

In one aspect of the present invention, a cooling module for a vehicle is provided, including at least two heat exchangers with holding brackets secured to the sides, and a support having two elastic bearings adapted to rest on carriers of the vehicle and secured to the holding brackets. The elastic bearings include an elastic element between at least first and second members whereby the heat exchangers are supported individually elastically.

In one form of this aspect of the present invention, the individual support is provided in the elastic bearings.

In another form of this aspect of the present invention, each elastic bearing has a moveable pressure plate lying on the elastic element on which a heat exchanger is positioned to form one of the supports. In a further form, below the pressure plate, each elastic bearing has at least one recess for the holding bracket of another heat exchanger adapted to form another support.

In a further form of this aspect of the present invention, the two members of each elastic bearing have at least a partially complementary form.

In a still further form of this aspect of the present invention, the pressure plate is located in a recess of the first member, whereby the recess extends into a complementary recess of the second member.

In yet another form of this aspect of the present invention, the first member of the two members of the elastic bearing is movable and is formed by a pressure plate which lies in a recess of the second member on the elastic element.

In yet another further form of this aspect of the present invention, the heat exchangers are arranged one behind the other in the direction of the cooling air flow with no bearing joints between them.

In still another form of this aspect of the present invention, the supports of the heat exchangers lie one over the other in the elastic bearings.

In yet another further form of this aspect of the present invention, the holding brackets are secured to the sides of the heat exchangers. In a further form, the holding brackets are separably secured to the sides of the heat exchangers.

In another aspect of the present invention, an elastic bearing is provided for supporting a cooling module with at least two heat exchangers, including a first member, a second member, and an elastic element between the first and second members, wherein the bearing supports the individual heat exchangers individually.

### BRIEF DESCRIPTION OF THE DRAWINGS

FIG. 1 is a perspective view of one side of a cooling module according to the present invention;

FIGS. 2-7 are perspective views of different elastic bearings, where:

FIG. 2 shows one embodiment wherein the bearing has a bent down leg;

FIG. 3 shows another embodiment in which the upper part can function as the pressure plate of the bearing;

FIG. 4 shows the FIG. 2 embodiment from the opposite side;

FIG. 5 shows another embodiment of a bearing with a bent down leg;

FIG. 6 shows the FIG. 5 embodiment from the opposite side;

FIG. 7 shows yet another embodiment; and

FIG. 8 is a cross-sectional view through the bearing of FIG. 7.

### DETAILED DESCRIPTION OF THE INVENTION

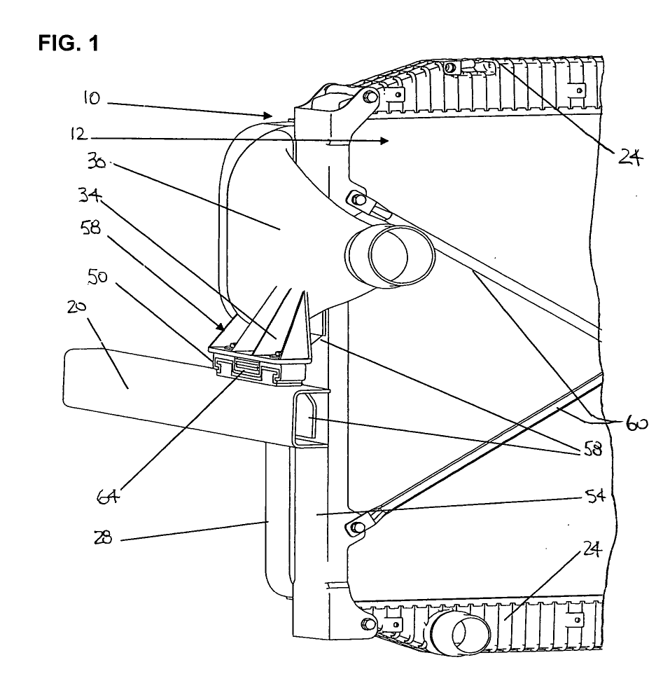

A cooling module according to the present invention may be incorporated into a vehicle (not shown), and in the illustrated embodiment includes only two heat exchangers: a charge air cooler 10 in the back (in the direction of viewing in FIG. 1 ) and a radiator 12 in the front, the back heat exchanger 10. Other parts belonging to the cooling module were omitted here for clarity of illustration. Similarly, only one of the two chassis beams 20 of the vehicle are indicated (with FIG. 1 showing only one side of the cooling module, since the other side, which is not shown, is designed identically and includes also the second chassis beam, a second elastic bearing as described below, and other identical parts.

The radiator 12 has an upper and a lower horizontally-arranged collecting tank 24, between which flat tubes for the coolant and the corrugated ribs introduced in between the tubes for cooling air such as are known are located (but are not shown). The cooling air accordingly flows perpendicular to the plane of the drawing through both coolers 10, 12.

On the other hand, the charge air cooler 10 has two vertically-arranged collecting tanks 28, one of which can be partly seen in FIG. 1. The charge air collecting tank 28 has an inlet connection and an outlet connection 30 for the charge air (only one of which is partly shown in FIG. 1). Each of the inlet and outlet connections 30 have a holding bracket 34, which serves to support the charge air cooler 10.

In the illustrated practical example, the collecting tanks 28, including the inlet and outlet connections 30, may be advantageously made of aluminum with a pressure casting method, in which case the design which has been known for more than 20 years may be used. In that case, the holding brackets 34 are made in one part with the connection 30 and at the same time are provided with reinforcements, such as can be seen in FIG. 1.

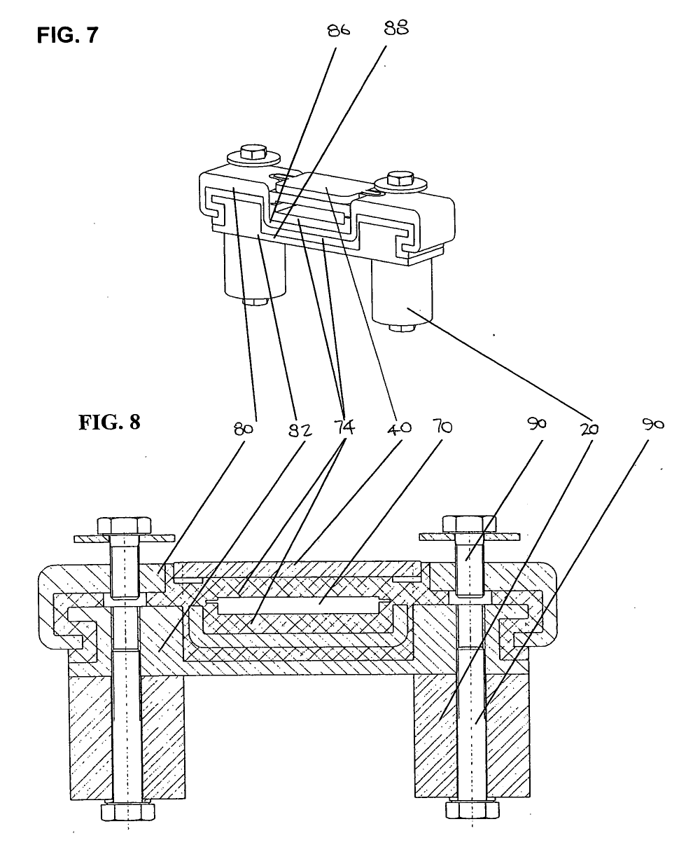

Each holding bracket 34 rests on an elastically supported pressure plate 40 of an elastic bearing 50, which will be explained in more detail later with reference to FIG. 7. The radiator 12 has side parts 54 which join the two collecting tanks 24, and holding elements 58 are fastened on the side parts 54 to support the radiator 12 in the elastic bearings 50. The two side parts 54 are joined together with the aid of cross braces 60.

In the practical example illustrated, two holding elements 58 are provided on both side parts 54. The holding elements 58 have sideways protruding right-angle bends 64, which, coming from the top and bottom, lie against one another and open below the pressure plate 40 into a corresponding recess 70, which is formed in the elastic element 74 of the elastic bearing 50. The two right-angle bends 64 could also be arranged relatively close to one another and introduced into separate recesses 70.

FIG. 8 shows the details of the two elastic bearings 50 in a middle longitudinal cross-sectional through the bearing shown in FIG. 7. The bearings 50 consist of a first or upper part 80 and a second or lower part 82. The two parts, 80, 82, have a complementary form to one another, which, among other things, is manifested by the fact that the two parts, 80, 82, overlap at the left and right edge in the manner of a clamp. The upper part 80 sits in the middle section with a recess 86 that has a complementary shape to recess 88 of the lower part 82. The elastic element 74 is between the two parts 80, 82. Below the second or lower part 82 are the chassis beams 20 (FIG. 1) of the motor vehicle. Fastening elements 90 are separably connected to the second or lower part 82 and serve to secure the holding bracket 34 on the first or upper part 80.

As FIG. 8 further shows, a vertically moveable pressure plate 40 is arranged as a third part in the recess or cavity of the first or upper part 80, which rests on the elastic element 74. In the position shown at which no load is applied, the pressure plate 40 protrudes somewhat above the first or upper part 80, as a result of which a spring path is made available. This overhang is reduced by the pressure of the elastic element 74 when, with the aid of the additional fastening elements 92, the holding bracket 34, which carries the weight of the charge air cooler 10 is fastened on the upper part 80. The degree of elasticity of the elastic element 74 may be advantageously selected to correspond to the bearing forces present. Furthermore, providing hollow cavities in the elastic element 74 can exert an influence on the elastic behavior. In the elastic element 74 of the practical example, the already-mentioned recess 70 is present, which approximately corresponds to the cross-section of the right-angle bend 64 on the holding elements 54 in order to be able to incorporate this in it.

Since there are no horizontal bearing joints between the heat exchangers 10 and 12 according to the invention, the replacement of individual heat exchangers (e.g., in the case of service) may be done more simply. Further, as contrasted with the prior art in which one of the heat exchangers must assume the weight and the acceleration forces of the other heat exchanger, a correspondingly stable design is provided. Moreover, cooling modules according to the present invention may be advantageously provided in motor vehicles, which are also assigned special frame constructions from time to time.

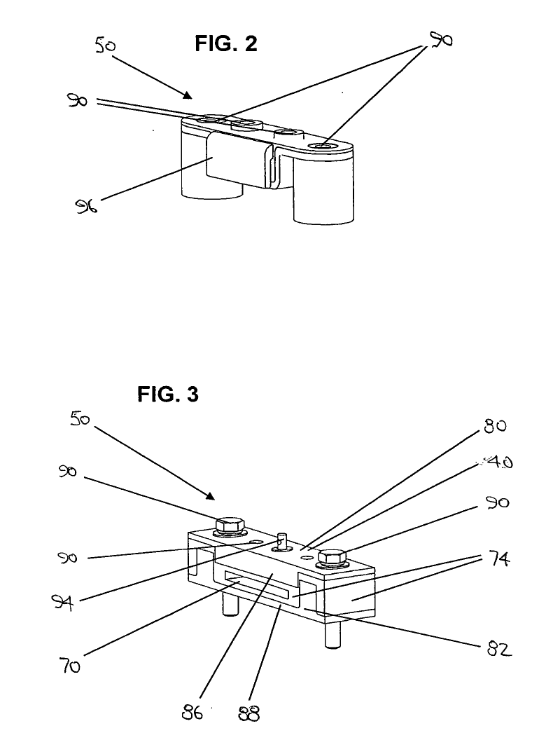

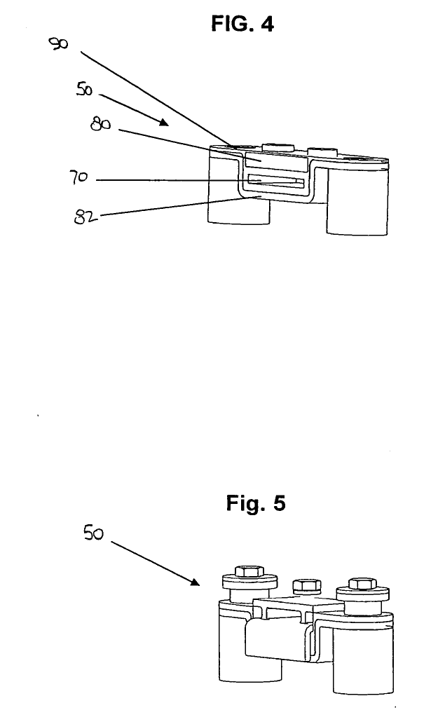

It should be appreciated further that advantages of the present invention may also be obtained with changed or simplified designs of the elastic bearing 50, such as illustrated in FIGS. 2-6 but without deviating from the basic idea of the invention.

As shown in FIG. 3, the bearings 50 can be designed so that the first or upper part 80 can also assume the function of the described pressure plate 40. The first or upper part 80 or the pressure plate 40 and the second or lower part 82 are generally designed complementarily and engage into one another. The two reinforced legs of the second or lower part 82 permit stable fastening on the chassis beam 20 with the aid of the fastening elements 90. A pin 94 or the like can be provided extending from the lower part 82 up through the upper part 80 so as to protrude upwardly therefrom. With such a pin 94, the bearing 50 can be applied and held on the pre-mounted cooling module.

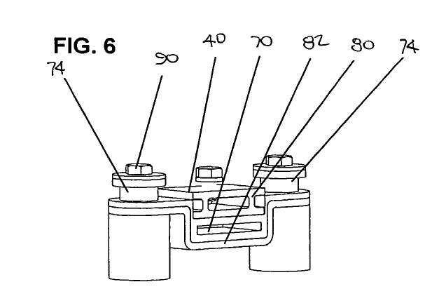

As shown by FIGS. 2 and 5, a bent-down leg 96 may be advantageously provided on the first or upper part 80 in order to prevent the upper part 80 from slipping down together with the heat exchanger 10 in case of failure of the elastic element 74. However, the elastic elements may be advantageously connected solidly with the parts 80 and/or 82, for example, by vulcanizing or gluing. Joints with positive locking can also be provided.

As shown by the other figures, in order to fasten the holding bracket 34 or charge air cooler 10, a separate fastening means (screw in the middle) can be provided. Furthermore, in contrast to FIGS. 7-8, the fastening of the bearings 50 on the beam chassis 20 can be done from the top side, which is also shown in FIGS. 2-6. The corresponding fastening means 90 extend accordingly from the top through the two openings that are farthest removed from one another. The two central neighboring openings serve for fastening the holding bracket 34 of the charge air cooler 10. In that instance, two complementary parts 80 and 82 can also be omitted. For example, the second or lower part 82 can be designed to be U-shaped and the vertically movable pressure plate 40 can be located as second or upper part between the U-shaped legs (see FIGS. 5-6).

FIGS. 5-6 also show a different design of the shape of the elastic element 74. The elastic element 74 extends upwardly to below the head of the fastening means 90. A sleeve is formed in this region according to the art, through which the fastening means 90 passes. As already described, the second or lower part 82 is deformed in a U-shape and it holds the elastic element 74 that extends to below the sleeves and also holds the pressure plate 40 arranged above it. The elastic element 74 can also be represented by several elastic parts that are not joined.

It should thus be appreciated that since the heat exchangers of the cooling module are supported individually, preferably in elastic bearings, no bearing joints are required between the heat exchangers, which bearings could adversely affect the expansion and contraction behavior of the heat exchanger. It should also be appreciated that the individual supports can be arranged in the elastic bearings over one another or next to one another. Furthermore, vibrations of one heat exchanger are advantageously not transferred, or at least transferred to a smaller extent, to the other heat exchangers.

Still other aspects, objects, and advantages of the present invention can be obtained from a study of the specification, the drawings, and the appended claims. It should be understood, however, that the present invention could be used in alternate forms where less than all of the objects and advantages of the present invention and preferred embodiment as described above would be obtained.

1. A cooling module for a vehicle, comprising:
at least two heat exchangers with holding brackets secured to the sides;
a support having two elastic bearings adapted to rest on carriers of the vehicle and secured to said holding brackets, wherein said elastic bearings include an elastic element between at least first and second members whereby the heat exchangers are supported individually elastically.

2. The cooling module of claim 1, wherein the individual support is provided in the elastic bearings.

3. The cooling module of claim 1, wherein each elastic bearing has a moveable pressure plate lying on the elastic element on which a heat exchanger is positioned to form one of the supports.

4. The cooling module of claim 3, wherein below the pressure plate, each elastic bearing has at least one recess for the holding bracket of another heat exchanger adapted to form another support.

5. The cooling module of claim 1, the two members of each elastic bearing have at least a partially complementary form.

6. The cooling module of claim 1, wherein the pressure plate is located in a recess of the first member, whereby the recess extends into a complementary recess of the second member.

7. The cooling module of claim 1, wherein the first member of the two members of the elastic bearing is movable and is formed by a pressure plate which lies in a recess of the second member on the elastic element.

8. The cooling module of claim 1, wherein the heat exchangers are arranged one behind the other in the direction of the cooling air flow with no bearing joints between them.

9. The cooling module of claim 1, wherein the supports of the heat exchangers lie one over the other in the elastic bearings.

10. The cooling module of claim 1, wherein the holding brackets are secured to the sides of the heat exchangers.

11. The cooling module of claim 10, wherein said holding brackets are separably secured to the sides of the heat exchangers.

12. An elastic bearing for supporting a cooling module with at least two heat exchangers, comprising a first member, a second member, and an elastic element between said first and second members, wherein the bearing supports the individual heat exchangers individually.
